(19) United States
(12) Patent Application Publication
(10) Pub. No.: US 2009/0248455 A1
(43) Pub. Date: Oct. 1, 2009

(54) Systems and Methods for Providing Enhanced Employee Benefits

(76) Inventor: Robert Thompson, Harrison, NY (US)

Correspondence Address: MCDERMOTT WILL & EMERY LLP, 600 13TH STREET, N.W., WASHINGTON, DC, 20005-3096, US

(21) Appl. No.: 12/416,673

(22) Filed: Apr. 1, 2009

Related U.S. Application Data
(60) Provisional application No. 61/072,582, filed on Apr. 1, 2008.

(51) Int. Cl. G06Q 40/00; G06Q 50/00; G06Q 20/00

(52) U.S. Cl. 705/4; 705/35

(57) ABSTRACT

The present inventions provide improved funding and administrative arrangements that allow an employer to provide enhanced benefits to certain employees. In general, the arrangement includes means by which the cost of certain insurance, such as life insurance, is reduced through the use of a trust and financing contract. Proceeds from the financing contract are used to pay premiums on the insurance to reduce the cost of that insurance to the employee. The insurance policy may be used to collateralize the financing contract. When a qualifying event occurs, the employee (or designated beneficiaries) is paid a predefined benefit amount and the financing contract is paid off. One benefit of such an arrangement is that it is portable with the employee, who may continue to retain the benefit of the insurance even though he or she may change jobs, or may be unemployed or retired.

### PRIORITY CLAIM

This application claims priority pursuant to 35 U.S.C. § 119 to U.S. Provisional Application Ser. No. 61/072,582 filed Apr. 1, 2008.

### BACKGROUND OF THE INVENTION

The present invention relates to enhanced employee benefit programs, and more particularly, to systems and methods of reducing the costs and improving the flexibility and portability of such programs.

Employers, whether corporations, professional partnerships or other entities, have long acknowledged the special insurance and other benefit needs of partners, key employees, and other highly compensated individuals within their organization. This group of key employees has often been defined as a special subset of the company's employee group to allow the company to better provide for their insurance and/or benefits needs. These “carve out” programs often provide additional benefit options not generally found in the basic employee benefit program, such as the availability of enhanced insurance options, planning flexibility, and corporate security. Such programs often serve as incentives for the hiring and retention of such individuals.

Thus, a need exists for systems and methods which offer insurance or other benefit products at reduced rates to such highly compensated individuals. There is also a need for such products to be portable, allowing employees to maintain coverage beyond their period of employment with a specific organization.

### BRIEF DESCRIPTION OF THE DRAWINGS

The above and other objects and advantages of the present invention will be apparent upon consideration of the following detailed description, taken in conjunction with the accompanying drawings, in which like reference characters refer to like parts throughout, and in which:

FIG. 1 illustrates the inception and operation of a benefit program constructed in accordance with the principles of the present invention.

FIG. 2 illustrates certain events that occur upon payment of a life insurance benefit in accordance with certain aspects of the present invention.

FIG. 3 illustrates some of the steps involved in a computer implemented embodiment of the present invention as illustrated in FIGS. 1 and 2.

### SUMMARY OF THE INVENTION

It is contemplated that the subject matter described herein may be embodied in many forms. Accordingly, the embodiments described herein are provided to illustrate and convey the present inventions to one of ordinary skill in the art, and are not to be considered limitations.

The present inventions provide improved funding and administrative arrangements that allow an employer to provide enhanced benefits to certain employees. In general, the arrangement includes means by which the cost of certain insurance, such as life insurance, is reduced through the use of a trust and financing contract. Proceeds from the financing contract are used to pay premiums on the insurance to reduce the cost of that insurance to the employee. The insurance policy may be used to collateralize the financing contract. When a qualifying event occurs, the employee (or designated beneficiaries) is paid a predefined benefit amount and the financing contract is paid off.

One benefit of such an arrangement is that it is portable with the employee, who may continue to retain the benefit of the insurance even though he or she may change jobs, or may be unemployed or retired.

One specific embodiment of the present invention is directed towards a portable life insurance product, including a trust, a life insurance contract that insures a life of an insured individual, wherein the trust is the beneficiary of the life insurance contract, and the death benefit for the life insurance contract includes a defined benefit amount which is to be paid to the insured individual or designated beneficiaries; and at least one finance contract, which is at least partially collateralized by the life insurance contract, and provides funds to the trust for premium payments on the life insurance contract.

Another specific embodiment of the present invention is directed towards a method for reducing life insurance premiums for selected individuals associated with an organization, including: obtaining a life insurance contract that insures the life of the insured individual, wherein a trust is the beneficiary of the life insurance contract, and the death benefit for the life insurance contract includes a defined benefit amount which is to be paid to the insured individual, entering into a finance contract with the trust, the finance contract being collateralized by the life insurance contract, paying premiums on the life insurance contract using the proceeds from the finance contract and additional funds provided by the insured individual or a third party, and upon payment of the death benefit to the trust, paying the defined death benefit from the trust to trust beneficiaries, and paying off the finance contracts.

Another specific embodiment of the present invention is directed towards a computer-readable medium having stored thereon a plurality of sequences of instruction including sequences of instructions, which, when executed by one or more processors cause an electronic device to: obtain a life insurance contract that insures the life of the insured individual, wherein a trust is the beneficiary of the life insurance contract, and the death benefit for the life insurance contract includes a defined benefit amount which is to be paid to the insured individual, enter into a finance contract with the trust, the finance contract being collateralized by the life insurance contract, pay premiums on the life insurance contract using the proceeds from the finance contract and additional funds provided by the insured individual or a third party, and upon payment of the death benefit to the trust, pay the defined death benefit from the trust to trust beneficiaries, and paying off the finance contracts.

### DETAILED DESCRIPTION OF THE INVENTION

It is contemplated that the subject matter described herein may be embodied in many forms, including computer-based implementations. Accordingly, the embodiments described herein are provided to illustrate and convey the present inventions to one of ordinary skill in the art, and are not to be considered limitations.

Inception and Ongoing Operation

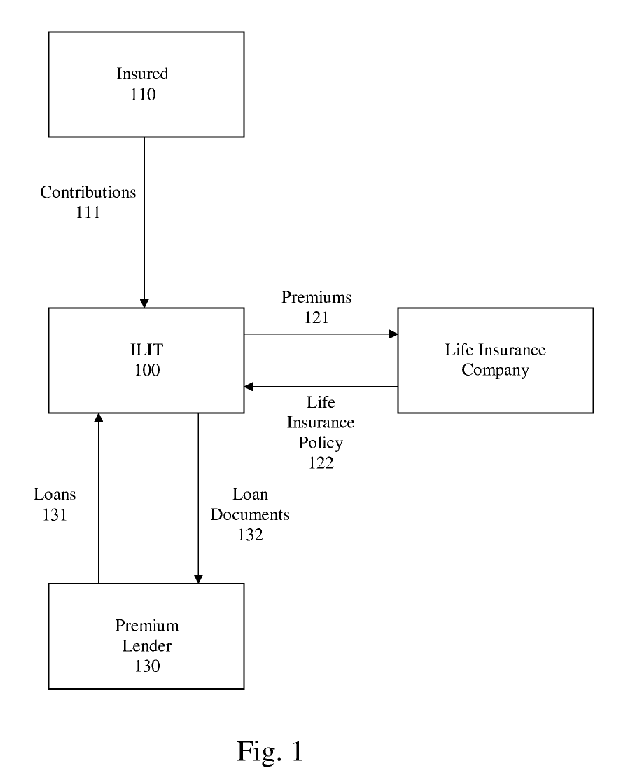

FIG. 1 illustrates an embodiment of a benefit program constructed in accordance with the principles of the present invention. As shown, a bankruptcy remote entity such as an Irrevocable Life Insurance Trust (“ILIT”) 100 may be created and associated with an insured individual 110. Insured individual 110 may be a person (or group of persons) defined or otherwise identified by an employer, business partner or other suitable entity associated with an organization sponsoring or providing the benefit.

In some embodiments, ILIT 100 may be a contract with a trustee to administer an insurance contract, and may not be able to be rescinded and/or modified after its creation. At the outset, ILIT 100 may apply for an insurance policy, such has a life insurance or other policy on insured 110. The amount of total benefit, such as death benefit, applied for may depend on a number of factors, which may include the defined death benefit insured 110 desires to secure, the amount of insurance that can be taken out on the life of insured 110, the anticipated life span of the insured 110, the anticipated interest rate on a loan 131 from premium lender 130 over the anticipated lifespan, and the cost of life insurance premium payments 121, etc. Other factors may be taken into consideration as well.

For example, in some embodiments, participants (i.e., insured 110) may be selected to be between about the ages of 30 and 75 (however, other age ranges that make financial sense may also be used). Based on such factors, a total benefit amount, such as total death benefit is calculated. Often a “base amount” of coverage can be offered by a life company 120 on a guaranteed issue basis, with an additional coverage amount provided on an elective basis with evidence of insured 110 insurability.

By applying for, or structuring the life insurance policy 122 such that a death benefit in excess of the defined death benefit will be obtained, ILIT 100 is in a position to seek financing using the assignment of the life insurance policy 122 as collateral. For example, ILIT 100 may pledge the proceeds from life insurance policy 122 as collateral for loan 131. Loan 131 may be obtained from premium lender 130, in exchange for loan documents 132, and its proceeds may be used to pay a portion of premium payments 121, reducing the amount of contributions 111 made to ILIT 100 from insured 110.

For example, an insured 110 may wish to have $1M of coverage, applicable while the insured is employed, which ordinarily may cost $10,000 per year. In this case, ILIT 100 may obtain $1.5M of coverage on behalf of insured 110, which is applicable even when the insured is unemployed or switches employers. Such a policy 122 may have a premium of $30,000 per year. Accordingly, loans 131 may be obtained in the amount of $22,000 per year, which ILIT 100 uses to partially pay the $30,000 annual premium payments 121. Insured 110 then only needs to make an $8,000 per year contribution to ILIT 100 for $1M of coverage, rather than pay a $10,000 per month premium that the insurance would cost otherwise. As a result, insured 110 maintain the $1M death benefit, with the premium cost reduced by 20%.

In other embodiments, insured 110 employers may pay all or a different portion of the contributions 111 on behalf of insured 110 to obtain the desired premium reduction and/or death benefit differential between ILIT 100 and insured 110 (e.g., a 10% or 30% reduction, even split of death benefit, etc.).

In addition, the interest rate applicable on loans 131 may depend of the rate of return of life insurance company 120 provides on insurance policy 122. In other embodiments, the rate applicable on the loans may be fixed, based on actual costs of funds of premium lender 130, based on a market index such as LIBOR, or a combination of these or other known factors.

Funding by premium lender 130 may be secured through a commercial paper conduit, such as a bond market, with the assignment of life insurance policy 122 acting as collateral for loans 131. One benefit of this arrangement is that the interest rate associated with the commercial paper conduit can be significantly less than that which may be obtained through another capital source, often on the order of 100 basis points or more per year. By reducing the amount of interest accrued, premium lender 130 incurs less cost associated with loans 131, providing for the potential for more value to ILIT 100. In other embodiments, funding by lender 130 may be obtained by a bank loan facility and/or the issuance of securities.

According to an aspect of the invention, ILIT 100 may obtain life insurance policy 122 from a highly-rated (on a financial basis) life insurance company 120, to reduce risk. Generally a “whole life” insurance policy is acquired from a mutual life insurance company (although certain types of term or hybrid of the two types may be used if desired). A benefit of selecting a whole life insurance policy is that a portion of the premium payments may be invested, if desired, and the resulting dividends may eventually become sufficient for the life insurance policy 122 to become self-funding.

The total death benefit of life insurance policy 122 is typically for an amount greater than that paid to insured 110 (e.g., as described above), with ILIT 100 designated as the beneficiary of policy 122. In this case, the proceeds of policy 122 are pledged to premium lender 130 as collateral for the loan 131.

Contributions 111 are collected and additional loans 131 may be secured periodically, as needed to make payments on premiums 121. It is generally desirable to secure loans 131 on an “as needed” basis, in order to minimize the interest accruing on outstanding loans 131. Often, life insurance policy 122 will require premiums 121 to be paid for only a certain amount of time, such as for ten years. In other instances, after a certain amount of time, life insurance policy 122 may be converted or modified such that no more premiums 121 are due (or the premiums are substantially reduced (e.g., to administration or maintenance fees)).

The above embodiment also allows for portability in the event of a change in employment, allowing the ILIT 100 to continue to own the life insurance policy 122 even after the insured 110 leaves their employer or cease working altogether. Furthermore, insured 110 may also continue to enjoy the benefit of the death benefit described above (assuming insured 110 and ILIT 100 continue to make the required capital contributions or such capital contributions are substantially fully paid). As a result, the insurance benefit is portable for both insured 110 and ILIT 100.

Death or Other Maturation of Life Insurance Contract

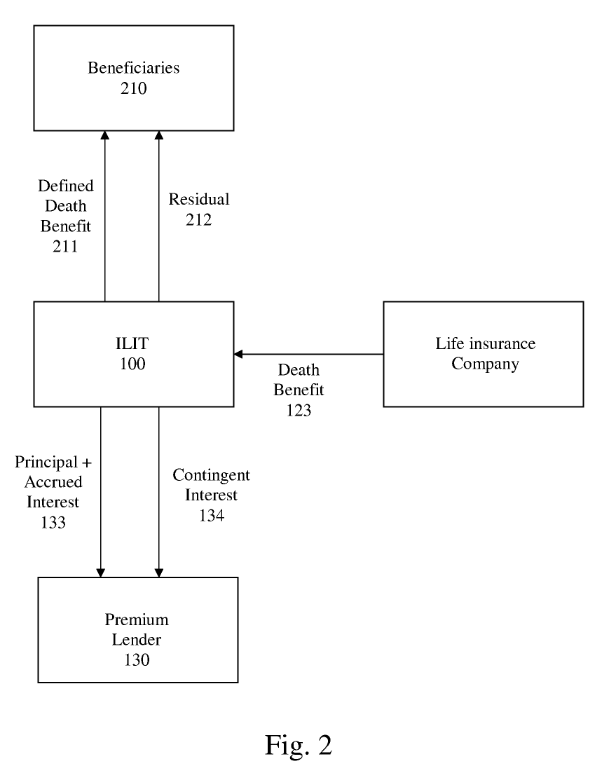

FIG. 2 depicts certain events that occur upon payment of a life insurance benefit in accordance with certain aspects of the present invention. More particularly, FIG. 2 illustrates how payments may flow upon death of insured 110 for the embodiment described in FIG. 1. However, it will be understood that events other than those specifically depicted may occur that cause life insurance policy 122 to mature (become payable). For example, certain insurance products may pay the benefit 123 upon diagnosis of a critical illness (or other qualifying payout event).

Upon the death or occurrence of a qualifying payout event of insured 110, life insurance company 120 pays death benefit 123 to ILIT 100. From this amount, the principle of loan 131 plus accrued interest 133 may be paid to premium lender 130 first. Next, defined death benefit 211 may be paid to beneficiaries 210, such as the insured's family or other designated beneficiaries (which may include insured 110 in the case of a qualifying payout event). After this amount is paid, premium lender 130 may receive contingent interest 134, which may include interest on the loan 131 over and above that received in 133. For example, premium lender 130 may receive an additional 8% interest on the loan (however, other amounts may be used, if desired). Lastly, beneficiaries 210 may receive any remaining funds after lender 130 is paid the contingent interest 134.

The embodiment above is one possible division of death benefit 123, and other splits as agreed to for the loan 131 by ILIT 100 and/or insured 110 may be implemented, if desired. Moreover, it will be understood that the order in which funds are paid may vary to achieve desired business goals. For example, beneficiaries 210 may be paid the defined death benefit before premium lender 130, with contingent interest 134 paid afterwards. Any suitable rearrangement of funds payout may be effected if desired.

It is also possible that prior to death or occurrence of a qualifying payout event of insured 110, certain amounts may be withdrawn respective of life insurance policy 122 from life company 120. An example of use of such funds is to pay principal and/or interest on loan 131 to premium lender 130.

Computer Implementation

In some embodiments, some or all aspects of the invention may be embodied on a computer readable medium and performed by one or more computers (not shown), in order to more effectively and efficiently establish and/or administer particular aspects of the invention. For example, given the potentially large size of some employee groups and the number of factors considered in evaluating various products offered in the insurance market, it may be impractical to perform some or all aspects of the invention manually. Thus, some or all of the aspects of the inventions described herein may be performed by a computer or network of computers based on software embodied on a computer readable medium in the form of instructions or code.

For example, one or more computer programs may be developed, in the form of source and/or executable code and be disposed on computer readable medium such as a CD ROM, jump drive, or other magnetic or optical storage media for performing or implementing any of the features described herein. Such computer code may also be disposed on a local or personal computer, a network computer or on a remote computer such a server as part of a distributed network such as a WAN or LAN, etc.

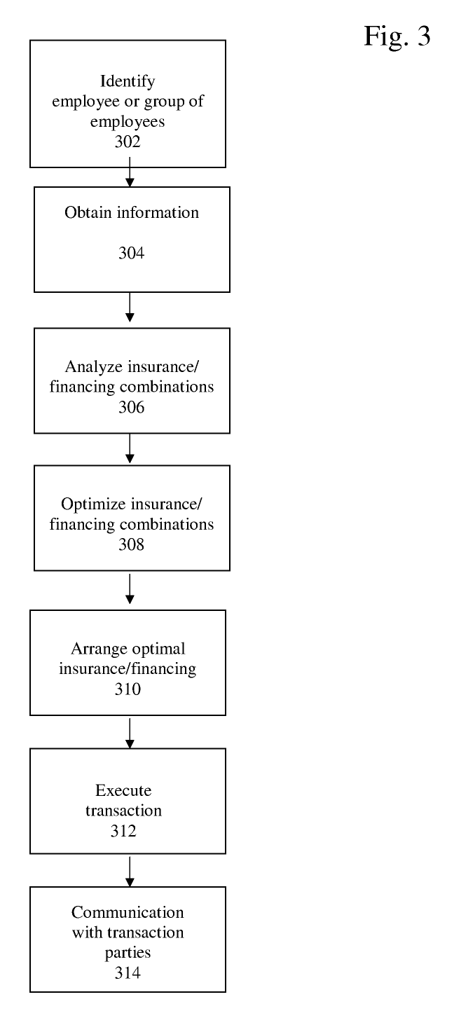

One such embodiment is generally depicted in the flow chart of FIG. 3, which illustrates some of the steps that may be performed by one or more computers based on one or more application programs developed in accordance with the principles of the present invention.

At step 302, information regarding an employee or group of employees may be considered for receiving additional benefits. Information on group or individual attributes, such as income level or general health, along with available products for such groups may be may be obtained and entered into a database, etc. An analysis of such information using known techniques may determine which employee or groups of employees may benefit from the present invention, and therefore should be approached to participate.

At step 304, information on the employee group and/or group members, such as personal information relating to health information may be obtained by having each employee fill out relevant insurance related documents, and entered into a database, etc. Some or all of this information may already be present in an existing employer database. In this case, the existing database may be used as the basis for performing the following steps.

Next, at step 306, this information is evaluated to develop a view on life expectancy of the group members. Based on the database information and life expectancy, a group of potential participants may be selected in view of one or more initial screening factors such as age, health, etc. to obtain a group for which the arrangement described herein may succeed.

For participants that satisfy the transaction criteria, possible insurance/financing combinations are created and analyzed to determine optimal insurance/financing arrangement (step 308). This may include consideration of several different life insurance factors such as policy amount, premiums, mortality, and life expectancy. This information may be obtained from one or more life insurance companies such as Northwestern Mutual or AXA (e.g., through online policy illustrations or may be quoted or customized on request). Financing component considerations may include, for example, interest rates, swaps, capital market requirements, cash flow, securities holder payment terms, etc. and may be available online or may be quoted or customized on request from various financing concerns such as Morgan Stanley. Once optimal insurance/financing combinations are formed, optimal insurance/financing is sourced (step 310), potentially with the help of insurance agents and/or financial intermediaries such as Morgan Stanley.

Next at step 312, once individual insureds and insurance/financing combinations are optimized and arranged, the transaction is documented as appropriate and executed. This may involve the use of one or more application programs in generating the transaction documents complete with relevant financial and demographic information. Following step 312, at step 314, certain communications with involved parties may occur (e.g., may be generated substantially automatically and may be completed by one or more application programs). These may include communicating with the employer, employee group, insurance carriers, financing providers, and carrying out any of the other tasks as described herein in connection with described inventions. Such communication at step 314 may further include one or more of the payout activities described in conjunction with FIG. 2 herein.

An embodiment of the present invention relates to a computer-readable medium having computer code thereon for performing various computer-implemented operations. The computer-readable media and computer code may be those specially designed and constructed for the purposes of the present invention, or they may be of the kind well known and available to those having skill in the computer software arts.

Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using XML, JavaScript, C, C++, or other scripting, markup and/or programming languages and development tools. Another embodiment of the invention may be implemented in hardwired circuitry in place of, or in combination with, machine-executable software instructions.

As will be apparent to those skilled in the art in light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A portable life insurance product, comprising:
a trust;
a life insurance contract that insures a life of an insured individual, wherein the trust is the beneficiary of the life insurance contract, and the death benefit for the life insurance contract includes a defined benefit amount which is to be paid to the insured individual or designated beneficiaries; and
at least one finance contract, which is at least partially collateralized by the life insurance contract, and provides funds to the trust for premium payments on the life insurance contract.

2. The portable life insurance product of claim 1 wherein the trust is an Irrevocable Life Insurance Trust (ILIT).

3. The portable life insurance product of claim 1 wherein an insured individual pays a portion of premium payments on the life insurance contract.

4. The portable life insurance product of claim 1 wherein the trust pays off the least one premium finance contract when the insured dies.

5. The portable life insurance product of claim 4 wherein the trust pays off the least one premium finance contract before the defined benefit amount is paid to the insured individual or designated beneficiaries.

6. The portable life insurance product of claim 1 wherein a lender that provides the least one premium finance contract is paid additional interest when the insured dies.

7. The portable life insurance product of claim 1 wherein at least a portion of the defined benefit amount is paid to the insured individual or designated beneficiaries upon the occurrence of a qualifying event.

8. A method for reducing life insurance premiums for selected individuals associated with an organization, comprising:
obtaining a life insurance contract that insures the life of the insured individual, wherein a trust is the beneficiary of the life insurance contract, and the death benefit for the life insurance contract includes a defined benefit amount which is to be paid to the insured individual;
entering into a finance contract with the trust, the finance contract being collateralized by the life insurance contract;
paying premiums on the life insurance contract using the proceeds from the finance contract and additional funds provided by the insured individual or a third party; and
upon payment of the death benefit to the trust, paying the defined death benefit from the trust to trust beneficiaries, and paying off the finance contracts.

9. The method of claim 8 wherein the trust is an Irrevocable Life Insurance Trust (ILIT).

10. The method of claim 8 wherein the trust pays off the finance contract when the insured individual dies.

11. The method of claim 9 wherein the trust pays off the finance contract before the defined benefit amount is paid to the insured individual or designated beneficiaries.

12. The method of claim 8 wherein a lender that provides the finance contract is paid additional interest when the insured individual dies.

14. The method of claim 8 wherein at least a portion of the defined benefit amount is paid to the insured individual or designated beneficiaries upon the occurrence of a qualifying event.

15. A computer-readable medium having stored thereon a plurality of sequences of instruction including sequences of instructions, which, when executed by one or more processors cause an electronic device to:
obtain a life insurance contract that insures the life of the insured individual, wherein a trust is the beneficiary of the life insurance contract, and the death benefit for the life insurance contract includes a defined benefit amount which is to be paid to the insured individual;
enter into a finance contract with the trust, the finance contract being collateralized by the life insurance contract;
pay premiums on the life insurance contract using the proceeds from the finance contract and additional funds provided by the insured individual or a third party; and
upon payment of the death benefit to the trust, pay the defined death benefit from the trust to trust beneficiaries, and paying off the finance contracts.

16. The computer readable medium of claim 15 wherein the trust is an Irrevocable Life Insurance Trust (ILIT).

17. The computer readable medium of claim 15 wherein the trust pays off the finance contract when the insured individual dies.

18. The computer readable medium of claim 17 wherein the trust pays off the finance contract before the defined benefit amount is paid to the insured individual or designated beneficiaries.

19. The computer readable medium of claim 15 wherein a lender that provides the finance contract is paid additional interest when the insured individual dies.

20. The computer readable medium of claim 15 wherein at least a portion of the defined benefit amount is paid to the insured individual or designated beneficiaries upon the occurrence of a qualifying event.
